(19) United States
(12) Patent Application Publication
(10) Pub. No.: US 2023/0150844 A1
(43) Pub. Date: May 18, 2023

(54) DEVICES FOR REMOVING METAL IONS FROM LIQUID

(71) Applicant: EEnotech, Inc., Sunnyvale, CA (US)

(72) Inventors: Hongxia Wang, Sunnyvale, CA (US); Yu Zhu, Sunnyvale, CA (US); Wanyue Li, Sunnyvale, CA (US)

(21) Appl. No.: 17/525,419

(22) Filed: Nov. 12, 2021

(51) Int. Cl. C02F 1/461; C02F 1/00

(52) U.S. Cl. CPC C02F 1/46109; C02F 1/001; C02F 2001/46161; C02F 2001/46133; C02F 2201/4617

(57) ABSTRACT

An apparatus for metal-ion removal includes a conduit including an inlet to receive a liquid and an outlet to discharge the liquid, a first porous electrode and a second porous electrode disposed in the conduit, and a power source configured to provide power to the first porous electrode and the second porous electrode. The first porous electrode and the second porous electrode are separated by a gap. The first porous electrode is extended in a first direction. A flow direction of the liquid in the conduit is not in parallel with the first direction.

### BACKGROUND

Efficient extraction of metal ions from water is of interest for various applications, such as resource extraction from seawater and water treatment. Removing metal ions from water is an important process, not only for drinking and sanitation purposes but also for industrial use. It is desirable to provide a water filter device for household and industrial use that is capable to remove metal ions from water and other liquid.

### SUMMARY

Described herein are an apparatus for removing metal ions from water or other liquid for drinking and industrial uses.

In one embodiment, the disclosure describes an apparatus that includes a conduit including an inlet to receive a liquid and an outlet to discharge the liquid, a first porous electrode and a second porous electrode disposed in the conduit, and a power source configured to provide power to the first porous electrode and the second porous electrode. The first porous electrode and the second porous electrode are separated by a gap, where the gap is formed by fixed locations of electrodes or by inserting a nonconductive mesh or porous material therein. The first porous electrode is extended in a first direction. A flow direction of the liquid in the conduit is not in parallel with the first direction.

In some embodiments, the power source provides an electrical field between the first porous electrode and the second porous electrode such that metal ions are electro-deposited onto a surface of the first porous electrode/material or the second porous electrode/material.

In some instances, each of the first porous electrode and the second porous electrode comprises a plurality of sheet electrodes. The sheet electrodes of the first porous electrode are interlaced and in parallel with the sheet electrodes of the second porous electrode. In such a configuration, the flow direction of the liquid in the conduit is substantially in parallel with a normal direction of the sheet electrodes.

In some instances, the first porous electrode and the second porous electrode are sheet electrodes bent in a zig-zag shape with the gap separating the first porous electrode and the second porous electrode. In such a configuration, the flow direction of the liquid in the conduit traverses the zig-zag shaped sheet electrodes.

In some embodiments, the apparatus further includes a case that houses the conduit. The case includes a reservoir surrounding the conduit. The conduit may include a side wall having holes such that the liquid communicates from an inside of the conduit to the reservoir or from the reservoir to the conduit.

In some embodiments, the case includes a first compartment connected to the inlet, a second compartment configured to house the first porous electrode and the second porous electrode, and a separation structure disposed between the first compartment and the second compartment. The separation structure includes holes to allow the liquid to communicate from the first compartment to the second compartment.

In some embodiment, the first porous electrode and the second porous electrode comprise one of carbon felt or graphite felt with fibers. The fibers have a diameter of 1-100 μm inclusive.

In some embodiments, each of the first porous electrode and the second porous electrode has a thickness of 0.5-100 mm inclusive.

In some embodiments, at least one of the first porous electrode and the second porous electrode is functionalized with a material. As a non-limiting example, the material includes an amidoxime-based chemical. The material may include a porous coating disposed on a surface of at least one of the first porous electrode and the second porous electrode.

In some embodiments, the power source provides a direct current or an alternating current to the first porous electrode and the second porous electrode.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 is a diagram illustrating a water filter device that is cut in half along a vertical plane to show its internal configurations, according to one example embodiment.

FIG. 2 is a diagram illustrating another water filter device that is cut in half along a vertical plane to show its internal configurations, according to one example embodiment.

FIG. 3 is a diagram illustrating yet another water filter device that is cut in half along a vertical plane to show its internal configurations, according to one example embodiment.

FIG. 4 is a diagram illustrating yet another water filter device that is cut in half along a vertical plane to show its internal configurations, according to one example embodiment.

FIG. 5A is a diagram illustrating another water filter device, according to one example embodiment. FIG. 5B is a diagram illustrating the water filter device shown in FIG. 5A that is cut in half along a vertical plane to show its internal configurations.

FIG. 6A is a diagram illustrating another water filter device, according to one example embodiment. FIG. 6B is a diagram illustrating the water filter device shown in FIG. 5A that is cut in half along a vertical plane to show its internal configurations.

FIG. 7 is a diagram illustrating a coiled electrode set, according to one example embodiment.

FIG. 8 is a diagram illustrating another electrode set, according to one example embodiment.

FIG. 9 is a diagram illustrating a zig-zag-shaped electrode set, according to one example embodiment.

FIG. 10A is a scanning electron microscopy (SEM) image of an example electrode material. FIG. 10B is an SEM image of the electrode material shown in FIG. 10A with a higher magnification.

FIG. 11 is a diagram illustrating another water filter device, according to one example embodiment.

FIG. 12A is a diagram illustrating a water filter device that includes two water filter units stacked together to form a tandem configuration, according to one example embodiment.

FIG. 12B is a diagram illustrating a water filter device that includes three water filter units stacked together to form a tandem configuration, according to one example embodiment.

FIG. 13 is a diagram illustrating performances of the water filter device shown in FIG. 1 in removing copper ions.

FIG. 14 is a diagram illustrating performances of the water filter device shown in FIG. 1 in removing lead ions.

FIG. 15 is a diagram illustrating performances of the water filter device shown in FIG. 1 that has two pairs of coiled electrodes in removing lead ions.

### DETAILED DESCRIPTION OF EMBODIMENTS

In the following description, certain specific details are set forth in order to provide a thorough understanding of various embodiments of the invention. However, one skilled in the art will understand that the invention may be practiced without these details. Moreover, while various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

Various embodiments described herein are directed to apparatuses for removing metal ions from water and other liquids for drinking and industrial uses. In the examples provided herein, these water- or liquid-treating apparatuses are called water filter devices. In one non-limiting example, a water filter device includes a conduit that has an inlet to receive a liquid and an outlet to discharge the liquid, a first porous electrode and a second porous electrode disposed in the conduit, and a power source configured to provide power to the first porous electrode and the second porous electrode. The first porous electrode and the second porous electrode are separated by a gap. A flow direction of the liquid in the conduit is designed such that it is not in parallel with a direction in which the first porous electrode and the second porous electrode are extended. Various water filter devices are provided herein.

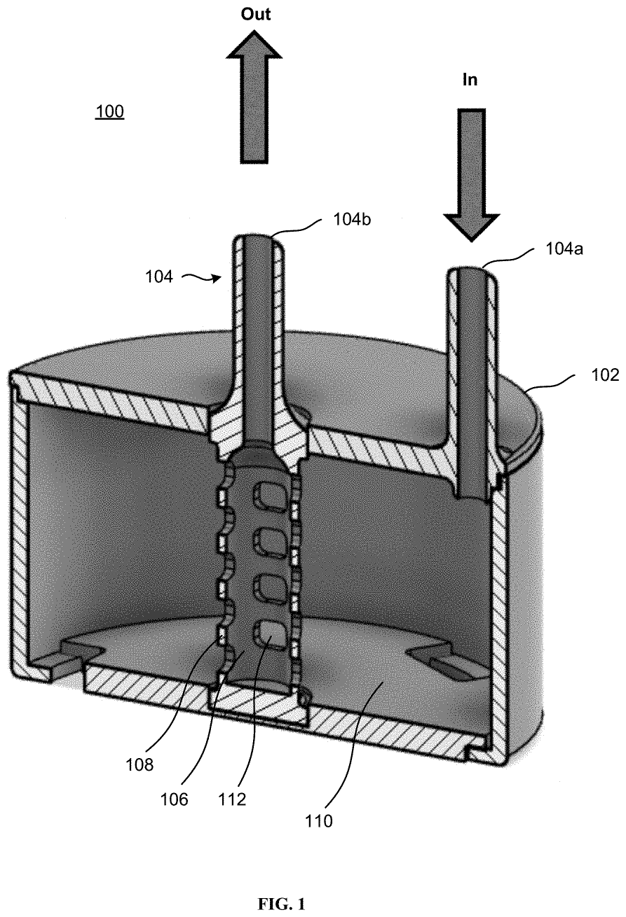

Reference is made to FIG. 1. FIG. 1 is a diagram illustrating a water filter device 100 that is cut in half along a vertical plane to show its internal configurations, according to one example embodiment. The water filter device 100 includes a case 102 and a conduit 104 configured to receive pre-treated liquid and discharge treated liquid. The conduit 104 includes an inlet 104a that receives the pre-treated liquid and an outlet 104b that outputs the treated liquid. The inlet 104a and the outlet 104b may include fitting mechanisms (not shown) to connect with an upstream pipe or container and a downstream pipe or container, respectively. In the illustrated embodiment, the inlet 104a and the outlet 104b are both disposed on a top surface of the case 102, where the inlet 104a is disposed close to an edge of the top surface and the outlet 104b is disposed at a center of the top surface. However, this configuration is provided merely as an example. Other configurations are contemplated. For example, one of the inlet and the outlet may be disposed on the top portion of the case, while the other one is disposed on the bottom portion or a side portion of the case.

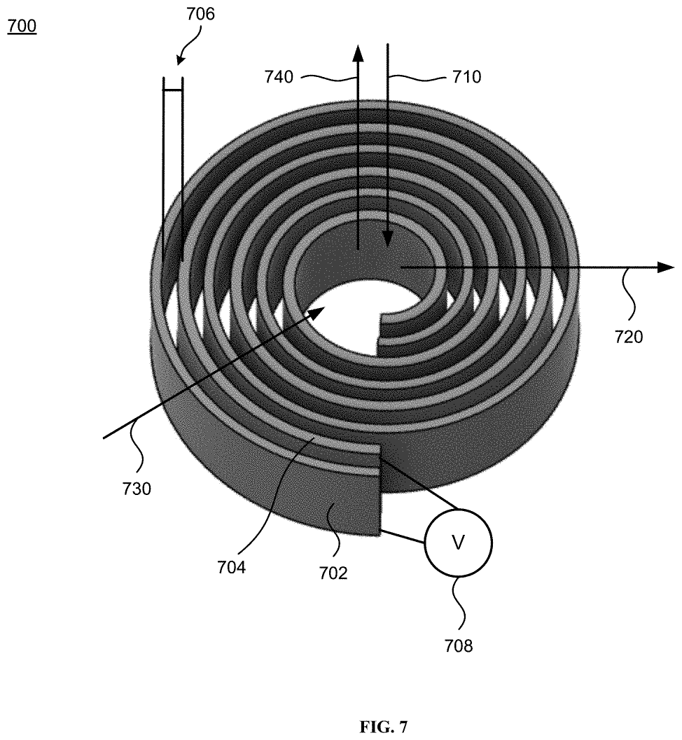

The conduit 104 further includes an electrode fitting compartment 106 connected to the outlet 104b. The electrode fitting compartment 106 is configured to accommodate electrodes such as that depicted in FIG. 7. The electrode fitting compartment 106 includes a side wall 108 disposed inside the case 102. The side wall 108 is surrounded by a reservoir 110 of the case 102. The reservoir 110 is connected to the inlet 104a. The side wall 108 of the electrode fitting compartment 106 includes holes 112 to allow the reservoir 110 to be in fluid communication with the inside of the electrode fitting compartment 106. The water filter device 100 further includes a power source (not shown) coupled to the electrodes (not shown) disposed in the electrode fitting compartment 106.

In an example, the pre-treated liquid (or water) is inputted into the reservoir 110 from the inlet 104a. The pre-treated liquid fills in the reservoir 110 and is forced to move through the holes 112 of the side wall 108 to enter the electrode fitting compartment 106. At least a pair of sheet electrodes (e.g., electrodes 702 and 704 of FIG. 7) are fitted in the electrode fitting compartment 106. The sheet electrodes are porous (e.g., referring to FIGS. 10A and 10B showing pores of the electrodes) to allow the liquid to pass through. As the liquid moves through the sheet electrodes, the power source provides an electrical field between porous electrodes such that metal ions are electro-deposited onto a surface of the porous electrodes so as to remove metal ions from the liquid. The post-treated liquid is then discharged from the outlet 104b connected to the electrode fitting compartment 106.

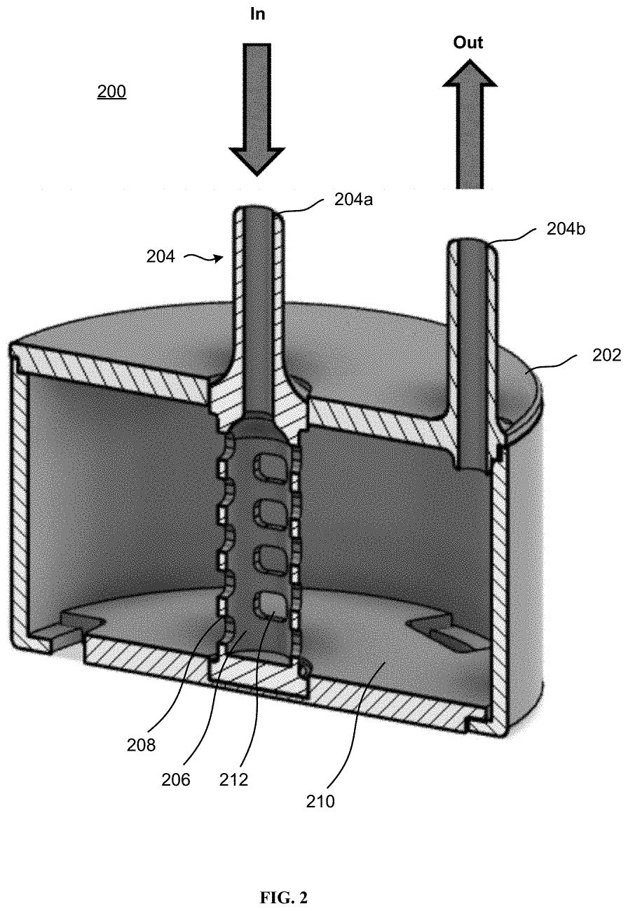

FIG. 2 is a diagram illustrating a water filter device 200 that is cut in half along a vertical plane to show its internal configurations, according to one example embodiment. The water filter device 200 includes a case 202 and a conduit 204 configured to receive pre-treated liquid and discharge treated liquid. The conduit 204 includes an inlet 204a that receives the pre-treated liquid and an outlet 204b that outputs the treated liquid. The inlet 204a and the outlet 204b may include fitting mechanisms (not shown) to connect with an upstream pipe or container and a downstream pipe or container, respectively. In the illustrated embodiment, the inlet 204a and the outlet 204b are both disposed on a top surface of the case 202, where the inlet 204a is disposed at a center of the top surface and the outlet 204b is disposed close to an edge of the top surface. The conduit 204 further includes an electrode fitting compartment 206 connected to the inlet 204a. The electrode fitting compartment 206 is configured to accommodate electrodes such as that depicted in FIG. 7. The electrode fitting compartment 206 includes a side wall 208 disposed inside the case 202. The side wall 208 is surrounded by a reservoir 210 of the case 202. The reservoir 210 is connected to the outlet 204b. The side wall 208 of the electrode fitting compartment 206 includes holes 212 to allow the reservoir 210 to be in fluid communication with the inside of the electrode fitting compartment 206. The water filter device 200 further includes a power source (not shown) coupled to the electrodes (not shown) disposed in the electrode fitting compartment 206.

In an example, the pre-treated liquid (or water) is inputted into the electrode fitting compartment 206 from the inlet 204a. The pre-treated liquid is forced through at least a pair of sheet electrodes (e.g., electrodes 702 and 704 of FIG. 7) disposed in the electrode fitting compartment 206. The sheet electrodes are porous (e.g., referring to FIGS. 10A and 10B showing pores of the electrodes) to allow the liquid to pass through. As the liquid moves through the sheet electrodes, the power source provides an electrical field between porous electrodes such that metal ions are electro-deposited onto a surface of the porous electrodes so as to remove metal ions from the liquid. The post-treated liquid is then moved to the reservoir 210 through the holes 212 on the side wall 208 of the electrode fitting compartment 206, and is discharged from the outlet 204b.

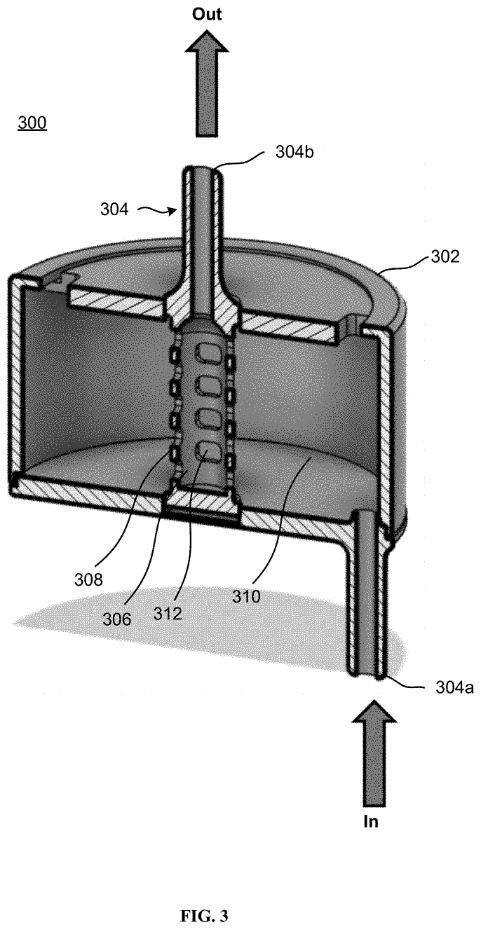

Reference is made to FIG. 3. FIG. 3 is a diagram illustrating a water filter device 300 that is cut in half along a vertical plane to show its internal configurations, according to one example embodiment. The water filter device 300 includes a case 302 and a conduit 304 configured to receive pre-treated liquid and discharge post-treated liquid. The conduit 304 includes an inlet 304a that receives the pre-treated liquid and an outlet 304b that outputs the treated liquid. The inlet 304a and the outlet 304b may include fitting mechanisms (not shown) to connect with an upstream pipe or container and a downstream pipe or container, respectively. In the illustrated embodiment, the inlet 304a is disposed close to an edge of the bottom surface of the case 302. The outlet 304b is disposed at a center of the top surface of the case 302. However, this configuration is provided merely as an example. Other configurations are contemplated.

The conduit 304 further includes an electrode fitting compartment 306 connected to the outlet 304b. The electrode fitting compartment 306 is configured to accommodate electrodes such as that depicted in FIG. 7. The electrode fitting compartment 306 includes a side wall 308 disposed inside the case 302. The side wall 308 is surrounded by a reservoir 310 of the case 302. The reservoir 310 is connected to the inlet 304a. The side wall 308 of the electrode fitting compartment 306 includes holes 312 to allow the reservoir 310 to be in fluid communication with the inside of the electrode fitting compartment 306. The water filter device 300 further includes a power source (not shown) coupled to the electrodes (not shown) disposed in the electrode fitting compartment 306.

In an example, the pre-treated liquid (or water) is inputted into the reservoir 310 from the inlet 304a. The pre-treated liquid fills in the reservoir 310 and is forced to move through the holes 312 of the side wall 308 to enter the electrode fitting compartment 306. At least a pair of sheet electrodes (e.g., electrodes 702 and 704 of FIG. 7) are fitted in the electrode fitting compartment 306. The sheet electrodes are porous (e.g., referring to FIGS. 10A and 10B showing pores of the electrodes) to allow the liquid to pass therethrough. As the liquid moves through the sheet electrodes, the power source provides an electrical field between porous electrodes such that metal ions are electro-deposited onto a surface of the porous electrodes so as to remove metal ions from the liquid. The post-treated liquid is then discharged from the outlet 304b connected to the electrode fitting compartment 306.

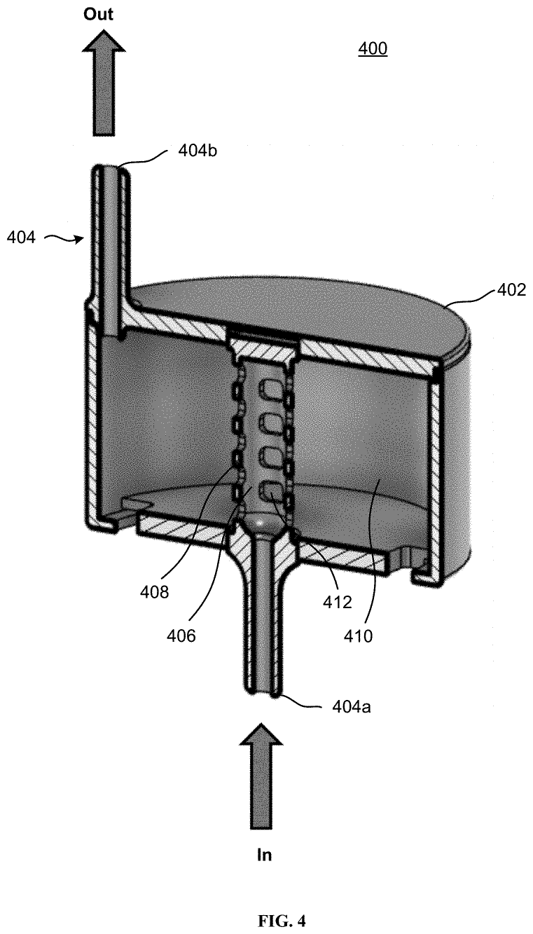

FIG. 4 is a diagram illustrating a water filter device 400 that is cut in half along a vertical plane to show its internal configurations, according to one example embodiment. The water filter device 400 includes a case 402 and a conduit 404 configured to receive pre-treated liquid and discharge treated liquid. The conduit 404 includes an inlet 404a that receives the pre-treated liquid and an outlet 404b that outputs the post-treated liquid. The inlet 404a and the outlet 404b may include fitting mechanisms (not shown) to connect with an upstream pipe or container and a downstream pipe or container, respectively. In the illustrated embodiment, the inlet 404a is disposed at a center of the bottom surface of the case 402. The outlet 404b is disposed close to an edge of the top surface of the case 402. However, this configuration is provided merely as an example. Other configurations are contemplated.

The conduit 404 further includes an electrode fitting compartment 406 connected to the inlet 404a. The electrode fitting compartment 406 is configured to accommodate electrodes such as that depicted in FIG. 7. The electrode fitting compartment 406 includes a side wall 408 disposed inside the case 402. The side wall 408 is surrounded by a reservoir 410 of the case 402. The reservoir 410 is connected to the outlet 404b. The side wall 408 of the electrode fitting compartment 406 includes holes 412 to allow the reservoir 410 to be in fluid communication with the inside of the electrode fitting compartment 406. The water filter device 400 further includes a power source (not shown) coupled to the electrodes (not shown) disposed in the electrode fitting compartment 406.

In an example, the pre-treated liquid (or water) is inputted into the electrode fitting compartment 406 from the inlet 404a. The pre-treated liquid is forced through at least a pair of sheet electrodes (e.g., electrodes 702 and 704 of FIG. 7) disposed in the electrode fitting compartment 406. The sheet electrodes are porous (e.g., referring to FIGS. 10A and 10B showing pores of the electrodes) to allow the liquid to pass therethrough. As the liquid moves through the sheet electrodes, the power source provides an electrical field between porous electrodes such that metal ions are electro-deposited onto a surface of the porous electrodes so as to remove metal ions from the liquid. The post-treated liquid is then moved to the reservoir 410 through the holes 412 on the side wall 408 of the electrode fitting compartment 406, and is discharged from the outlet 404b.

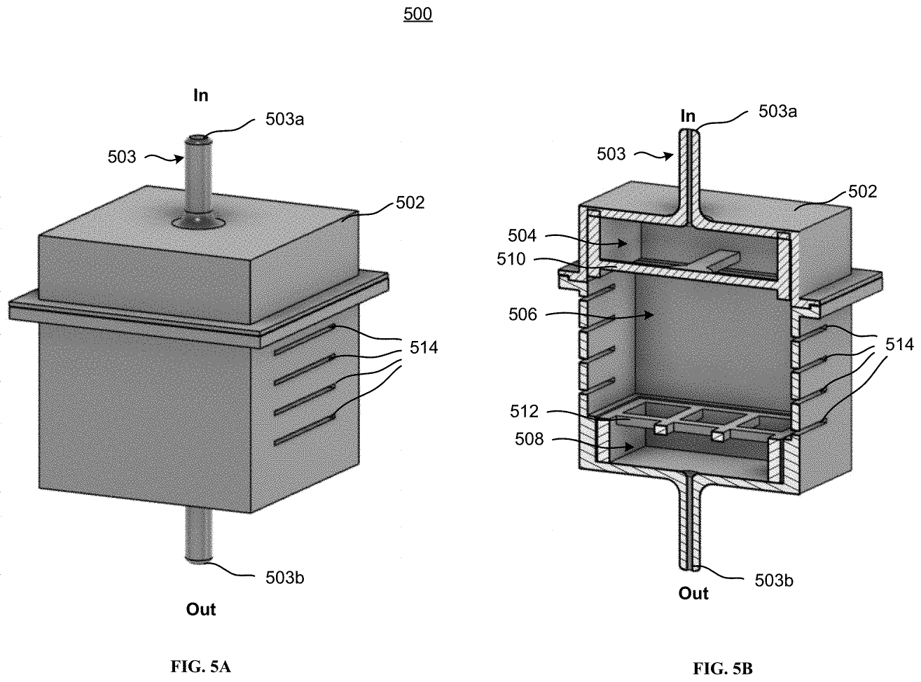

Reference is made to FIGS. 5A and 5B. FIG. 5A is a diagram illustrating a water filter device 500, according to one example embodiment. FIG. 5B is a diagram illustrating the water filter device 500 cut in half along a vertical plane to show its internal configurations. The water filter device 500 includes a case 502 and a conduit 503 configured to receive pre-treated liquid and discharge treated liquid. The conduit 503 includes an inlet 503a that receives the pre-treated liquid and an outlet 503b that outputs the post-treated liquid. The inlet 503a and the outlet 503b may include fitting mechanisms (not shown) to connect with an upstream pipe or container and a downstream pipe or container, respectively. In the illustrated embodiment, the inlet 503a is disposed on a top surface of the case 502, while the outlet 503b is disposed on a bottom surface of the case 502. However, this configuration is provided merely as an example. Other configurations of the inlet 503a and the outlet 503b are contemplated.

Referring to FIG. 5B, the case 502 includes a first compartment 504, a second compartment 506, and a third compartment 508. The first compartment 504 is connected to the inlet 503a, while the third compartment 508 is connected to the outlet 503b. The second compartment 506 is configured to house electrodes (not shown) therein. In some embodiments, the case 502 further includes a first separation structure 510 disposed between the first compartment 504 and the second compartment 506 and a second separation structure 512 disposed between the second compartment 506 and the third compartment 508. These separation structures may be provided to reinforce the structure of the case 502 and optional for the water filter device 500. The first separation structure 510 and the second separation structure 512 are provided with holes so that the compartments can be in fluid communication with each other.

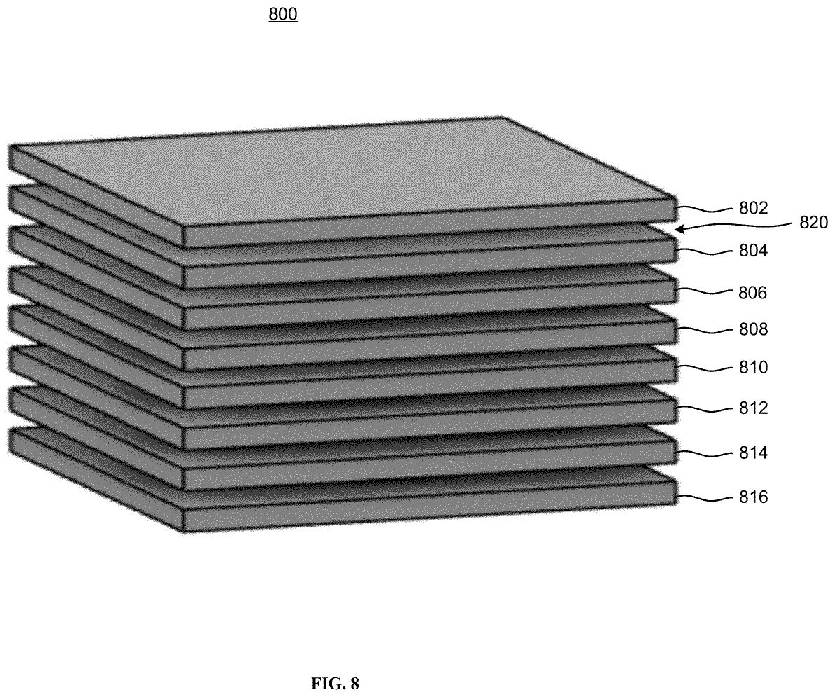

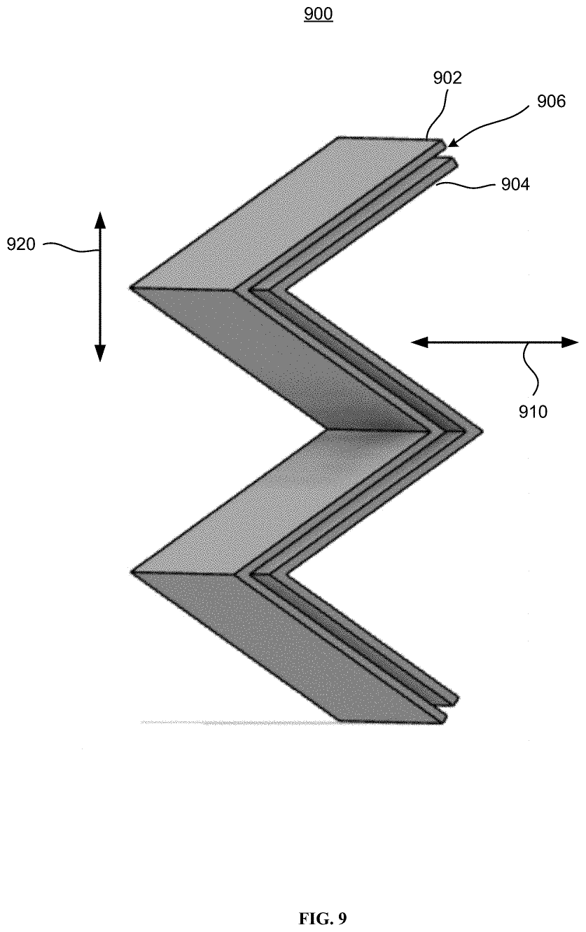

The second compartment 506 includes electrode fitting structures 514 to house the liquid-filtering electrodes (e.g., electrodes shown in FIGS. 8 and 9). For example, the electrode fitting structures 514 may be one or more slits, notches, latches, ribs, bumps, etc. formed on the side walls of the case 502 to secure electrodes in the second compartment 506. In the illustrated embodiment shown in FIGS. 5A and 5B, a plurality of slits are provided in the side walls of the case 502 as electrode fitting structures 514. Each of these slits may be fitted with an end portion of a sheet electrode. To protect the sheet electrodes from liquid/water pressure during the filtering process, the first separation structure 510 and the second separation structure 512 may be disposed on top and bottom of the second compartment to provide additional support for the sheet electrodes.

In one example, the pre-treated liquid (or water) is inputted into the first compartment 504 from the inlet 503a. The pre-treated liquid is then moved to the second compartment 506 through the holes in the first separation structure 510. In the second compartment 506, the pre-treated liquid is forced through at least a pair of sheet electrodes (e.g., sheet electrodes shown in FIGS. 8 and 9) disposed in the second compartment 506. The sheet electrodes are porous (e.g., referring to FIGS. 10A and 10B showing pores of the electrodes) to allow the liquid to pass therethrough. As the liquid moves through the sheet electrodes, a power source (not shown) provides an electrical field between porous electrodes such that metal ions are electro-deposited onto a surface of the porous electrodes so as to remove metal ions from the liquid. The post-treated liquid is then moved to the third compartment 508 through the holes of the second separation structure 512, and is discharged from the outlet 503b.

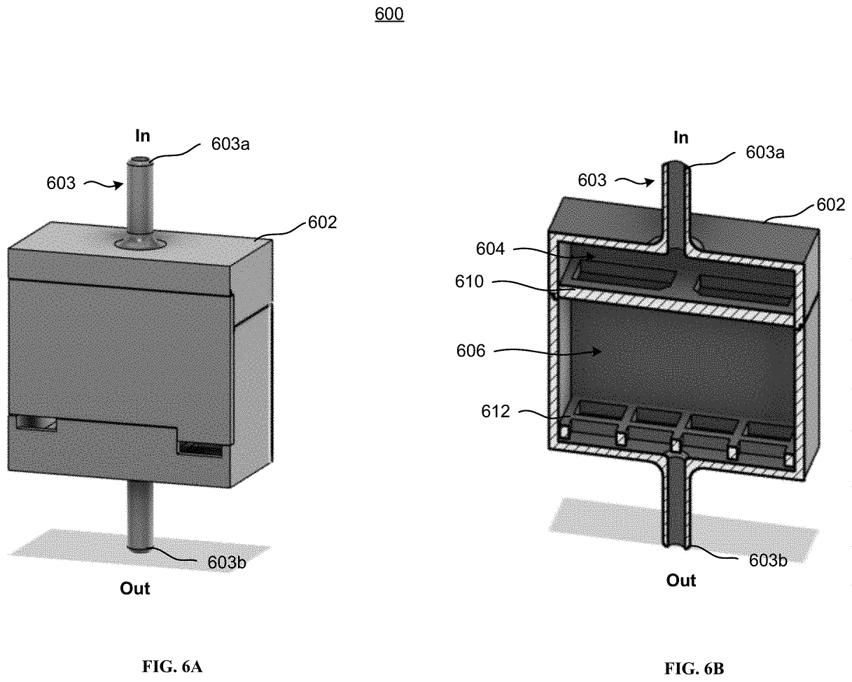

FIG. 6A is a diagram illustrating a water filter device 600, according to one example embodiment. FIG. 6B is a diagram illustrating the water filter device 600 cut in half along a vertical plane to show its internal configurations. The water filter device 600 includes a case 602 and a conduit 603 configured to receive pre-treated liquid and discharge treated liquid. The conduit 603 includes an inlet 603a that receives the pre-treated liquid and an outlet 603b that outputs the post-treated liquid. The inlet 603a and the outlet 603b may include fitting mechanisms (not shown) to connect with an upstream pipe or container and a downstream pipe or container, respectively. In the illustrated embodiment, the inlet 603a is disposed on a top surface of the case 602, while the outlet 603b is disposed on a bottom surface of the case 602. However, this configuration is provided merely as an example. Other configurations of the inlet 603a and the outlet 603b are contemplated.

Referring to FIG. 6B, the case 602 includes a first compartment 604, a second compartment 606, and a separation structure 608 disposed between the first compartment 604 and the second compartment 606. The first compartment 604 is connected to the inlet 603a, while the second compartment 608 is connected to the outlet 603b. The second compartment 606 is configured to house electrodes (not shown) therein. In some embodiments, the case 602 further includes a second separation structure 610 disposed between the second compartment 606 and the outlet 603b. These separation structures 608 and 610 may be provided to reinforce the structure of the case 602 and optional for the water filter device 600. The first separation structure 610 and the second separation structure 612 are provided with holes so that the compartments can be in fluid communication with each other.

In some embodiments, the second compartment 606 is configured to house Zig-Zag-shaped sheet electrodes (e.g., electrodes shown in FIG. 9). In some instances, the Zig-Zag-shaped sheet electrodes may be disposed vertically (as shown in FIG. 9) in the second compartment 606. In other instances, the Zig-Zag-shaped sheet electrodes may be disposed horizontally (when the electrodes shown in FIG. 9 is rotated 90 degrees) in the second compartment 606. In some embodiments, a portion of the sheet electrodes is disposed to abut against the side walls of the case 602 to ensure that the liquid/water is force to move through the electrodes.

In some embodiments, the second compartment 606 may include electrode fitting structures (not shown in FIGS. 6A and 6B) for housing the liquid-filtering electrodes (e.g., electrodes shown in FIGS. 8 and 9). For example, the electrode fitting structures may be one or more slits, notches, latches, ribs, bumps, etc. formed on the side walls of the case 602 to secure electrodes in the second compartment 606. To protect the sheet electrodes from liquid/water pressure during the filtering process, the first separation structure 608 and the second separation structure 610 may be disposed on top and bottom of the second compartment to provide additional support for the sheet electrodes.

In one example, the pre-treated liquid (or water) is inputted into the first compartment 604 from the inlet 603a. The pre-treated liquid is then moved to the second compartment 606 through the holes in the first separation structure 608. In the second compartment 606, the pre-treated liquid is forced through at least a pair of sheet electrodes (e.g., sheet electrodes shown in FIGS. 8 and 9) disposed in the second compartment 606. The sheet electrodes are porous (e.g., referring to FIGS. 10A and 10B showing pores of the electrodes) to allow the liquid to pass therethrough. As the liquid moves through the sheet electrodes, a power source (not shown) provides an electrical field between porous electrodes such that metal ions are electro-deposited onto a surface of the porous electrodes so as to remove metal ions from the liquid. The post-treated liquid is then moved through the holes of the second separation structure 610 and is discharged from the outlet 603b.

FIG. 7 is a diagram illustrating a coiled electrode set 700, according to one example embodiment. The coiled electrode set 700 includes a first porous electrode 702 and a second porous electrode 704 separated by a gap 706. In some embodiments, the gap 706 may be at least partially filled with an insulating mesh or porous separator. The first porous electrode 702 and the second porous electrode 704 are coupled to a power resource 708. The power source 708 is configured to provide power to the porous electrodes 702 and 704. In one embodiment, the power source 708 supplies a first type of voltage to the first porous electrode 702, and supplies a second type of voltage to the second porous electrode 704. The second type is opposite to the first type. For example, the first type and the second type could be positive and negative, respectively, or vice versa. In some embodiments, a voltage difference between the first type of voltage and the second type of voltage is about 0 and to about 40 Volts or about 5 Volts and to about 40 Volts. In some embodiments, a voltage across the porous electrodes alternates between a negative value and zero. For example, a square wave with voltages of −5 V to 0 V and frequency of 400 Hz was chosen based on fast kinetics and minimum water splitting.

In some embodiments, the power source 708 provides a direct current or an alternating current to the porous electrodes 702 and 704. In some embodiments, the alternating current includes sine waves or square waves.

In some embodiments, the pre-treated liquid may be introduced to the center of the coiled porous electrodes 702 and 704 as indicated by an arrow 710. The liquid then traverses the porous electrodes 702 and 704 as indicated by an arrow 720 that is substantially perpendicular to a tangential direction of the coiled electrodes 702 and 704. In other embodiments, the pre-treated liquid may be forced to traverse the porous electrodes 702 and 704 as indicated by an arrow 730 that is substantially perpendicular to a tangential direction of the coiled electrodes 702 and 704, to arrive at the center of the coiled electrodes 702 and 704. The post-treated liquid is then discharged at a vertical path to the top or bottom of the electrode set 700 indicated by an arrow 740. As the liquid moves through the electrodes 702 and 704, the power source 708 provides an electrical field between porous electrodes 702 and 704 such that metal ions are electro-deposited onto a surface of the porous electrodes 702 and 704 to remove metal ions from the liquid.

FIG. 8 is a diagram illustrating another electrode set 800, according to one example embodiment. The electrode set 800 includes sheet electrodes 802-816, each separated by a gap 820. The sheet electrodes 802-816 are porous to allow liquid/water to pass through. The sheet electrodes 802-816 are coupled to a power resource (not shown). Adjacent electrodes in the electrode set 800 are configured to receive different voltages so as to produce an electrical field therebetween. As a non-limiting example, a positive voltage is provided to the electrodes 802, 806, 810, and 814, and a negative voltage is provided to the electrodes 804, 808, 812, and 816, or vice versa. The pre-treated liquid is supplied from the top or the bottom of the electrode set 800 and traverses the electrodes 802-816. As the liquid moves through the electrodes 802-816, the power source provides an electrical field between porous electrodes 802-816 such that metal ions are electro-deposited onto a surface of the porous electrodes 802-816 to remove metal ions from the liquid. In some embodiments, each of the gaps 820 may be at least partially filled with an insulating mesh or porous separator.

FIG. 9 is a diagram illustrating a zig-zag-shaped electrode set 900, according to one example embodiment. The zig-zag-shaped electrode set 900 includes a first porous electrode 902 and a second porous electrode 904 separated by a gap 906. In some embodiments, the gap 906 may be at least partially filled with an insulating mesh or porous separator. The first porous electrode 902 and the second porous electrode 904 are coupled to a power resource (not shown). The power source is configured to provide power to the porous electrodes 902 and 904. In one embodiment, the power source supplies a first type of voltage to the first porous electrode 902, and supplies a second type of voltage to the second porous electrode 904. The second type is opposite to the first type. For example, the first type and the second type could be positive and negative, respectively, or vice versa. In some embodiments, a voltage difference between the first type of voltage and the second type of voltage is about 0 and to about 40 Volts or about 5 Volts and to about 40 Volts. In some embodiments, a voltage across the porous electrodes 902 and 904 alternates between a negative value and zero.

Liquid for treatment may be supplied to traverse the porous electrodes 902 and 904 horizontally (as indicated by an arrow 910) or vertically (as indicated by an arrow 920). As the liquid moves through the electrodes 902 and 904, the power source provides an electrical field between porous electrodes 902 and 904 such that metal ions are electro-deposited onto a surface of the porous electrodes 902 and 904 to remove metal ions from the liquid.

In some embodiments, the electrodes (e.g., electrodes 702, 704, 802-816, 902, 904) disclosed herein may include one of carbon felt or graphite felt with fibers. FIG. 10A is a scanning electron microscopy (SEM) image of an example electrode material. FIG. 10B is an SEM image of the electrode material shown in FIG. 10A with a higher magnification. As shown in FIGS. 10A and 10B, the electrodes are porous and contains micro pores between the fibers. In some embodiments, the fibers have a diameter of 1-100 μm inclusive. For example, the fibers may have a diameter of 1-10 μm, 1-20 μm, 1-30 μm, 1-40 μm, 1-50 μm, 1-60 μm, 1-70 μm, 1-80 μm, 1-90 μm, 5-10 μm, 5-20 μm, 5-30 μm, 5-40 μm, 5-50 μm, 5-60 μm, 5-70 μm, 5-80 μm, 5-90 μm, 10-20 μm, 10-30 μm, 10-40 μm, 10-50 μm, 10-60 μm, 10-70 μm, 10-80 μm, 10-90 μm, 20-30 μm, 20-40 μm, 20-50 μm, 20-60 μm, 20-70 μm, 20-80 μm, 20-90 μm, 30-40 μm, 30-50 μm, 30-60 μm, 30-70 μm, 30-80 μm, 30-90 μm, 40-50 μm, 40-60 μm, 40-70 μm, 40-80 μm, 40-90 μm, 50-60 μm, 50-70 μm, 50-80 μm, 50-90 μm, 60-70 μm, 60-80 μm, 60-90 μm, 70-80 μm, 70-90 μm, or 80-90 μm, inclusive.

In some embodiments, each of the electrodes disclosed herein has a thickness of 0.5-100 mm inclusive or 0.5-20 mm inclusive. In some embodiments, the electrodes may be functionalized with a material. For example, the material may be an amidoxime-based chemical. In some embodiments, the material may be in a form as a porous coating disposed on a surface of fibers of an electrode.

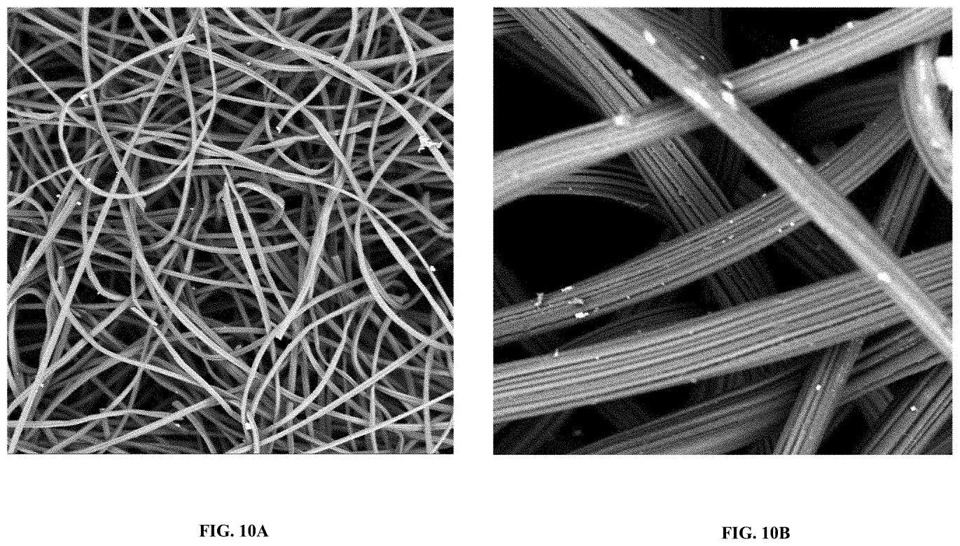

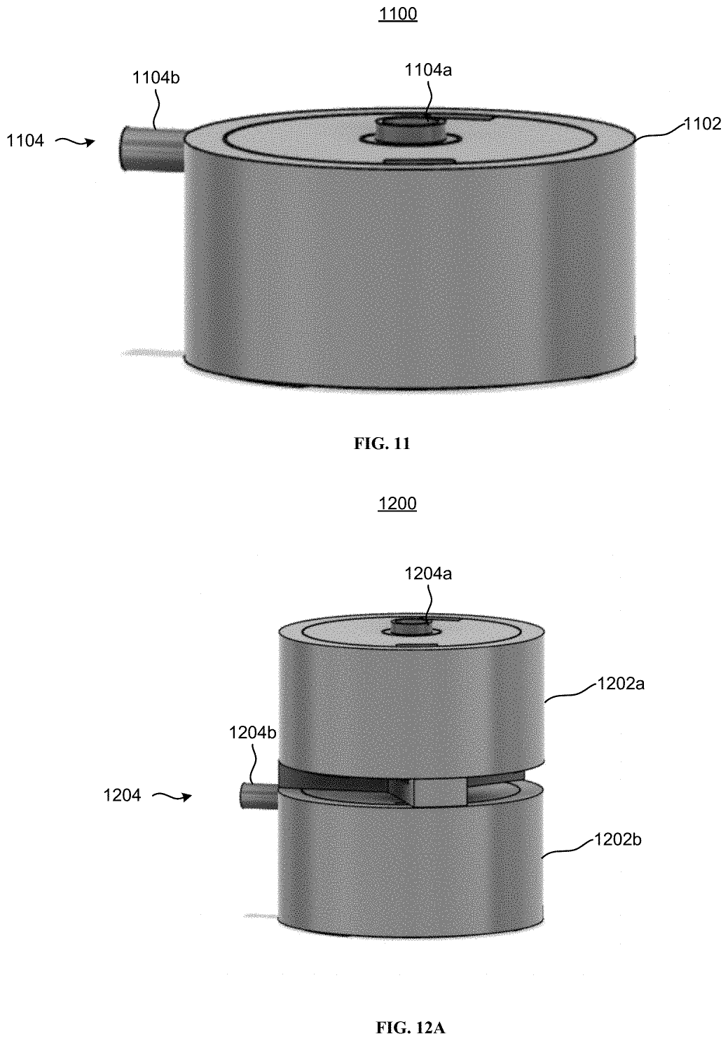

FIG. 11 is a diagram illustrating another water filter device 1100, according to one example embodiment. The water filter device 1100 includes a case 1102 and a conduit 1104 configured to receive pre-treated liquid and discharge post-treated liquid. The conduit 1104 includes an inlet 1104a disposed on a top portion of the case 1102 and configured to receive the pre-treated liquid. The conduit 1104 further includes an outlet 1104b disposed on a side portion of the case 1102 and configured to output the treated liquid. It should be understood that the location of the inlet 1104a and the outlet 1104b may be interchangeable depending on the design. The inlet 1104a and the outlet 1104b may include fitting mechanisms (not shown) to connect with an upstream pipe or container and a downstream pipe or container, respectively.

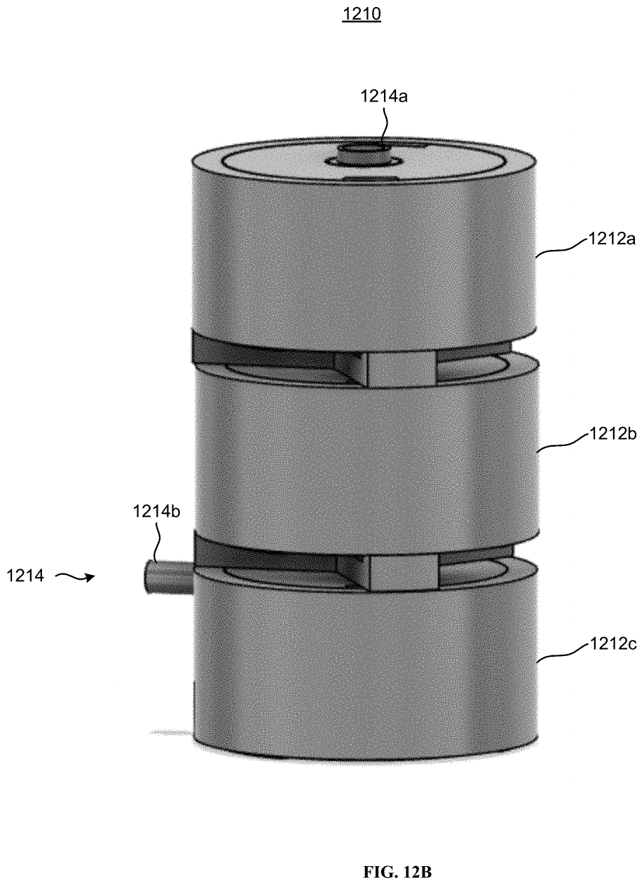

In some embodiments, two or more water filter units may form a tandem configuration to improve filtering performance (e.g., capacity and effectiveness). Examples are shown in FIGS. 12A and 12B. FIG. 12A is a diagram illustrating a water filter device 1200 that includes two water filter units stacked together to form a tandem configuration, according to one example embodiment. The water filter device 1200 includes two water filter units 1202a and 1202b, and a conduit 1204 configured to receive pre-treated liquid and discharge post-treated liquid. The water filter units 1202a and 1202b are stacked vertically to each other to reduce its footprint size. However, it should be noted that this disclosure is not limited to this particular configuration. Other tandem configurations are contemplated. For example, the two water filter units may be placed in juxtaposition to each other. The conduit 1204 includes an inlet 1204a disposed on a top portion of the water filter unit 1202a and configured to receive the pre-treated liquid. The conduit 1204 further includes an outlet 1204b disposed on a side portion of the water filter unit 1202b and configured to output the treated liquid. It should be understood that the location of the inlet 1204a and the outlet 1204b may be interchangeable depending on the design. The inlet 1204a and the outlet 1204b may include fitting mechanisms (not shown) to connect with an upstream pipe or container and a downstream pipe or container, respectively.

FIG. 12B is a diagram illustrating a water filter device 1210 that includes three water filter units stacked together to form a tandem configuration, according to one example embodiment. The water filter device 1210 includes three water filter units 1212a, 1212b, and 1212c, and a conduit 1214 configured to receive pre-treated liquid and discharge post-treated liquid. The water filter units 1212a-1212c are stacked vertically to each other. However, it should be noted that this disclosure is not limited to this particular configuration. Other tandem configurations are contemplated. For example, the three water filter units may be placed in juxtaposition to each other. In one embodiment, two of the water filter units may be stacked vertically while the third water filter is juxtaposed with one of the two vertically-stacked units.

The conduit 1214 includes an inlet 1214a disposed on a top portion of the water filter unit 1212a and configured to receive the pre-treated liquid. The conduit 1214 further includes an outlet 1214b disposed on a side portion of the water filter unit 1212c and configured to output the treated liquid. It should be understood that the location of the inlet 1214a and the outlet 1214b may be interchangeable depending on the design. The inlet 1214a and the outlet 1214b may include fitting mechanisms (not shown) to connect with an upstream pipe or container and a downstream pipe or container, respectively.

### Example I

Table 1 shows test result of metal-ion removal effectiveness for the water filter device 100 of FIG. 1. The electrodes of the water filter device 100 are made of carbon felt. The electrodes are 25 cm in length, 2.5 cm in height, and 3 mm in thickness. The to-be-filtered water has total dissolved solids (TDS) of 200 ppm and a pH of about 8.5. The water flows through the water filter device 100 in a flow rate of 0.5 or 1.5 L/min. The power source provides various DC voltages of 2.5-10 V and an AC voltage between 0-10 V in 10 or 100 Hz. The removal rate of copper metal ions are effective at about 65% to about 90%.

TABLE 1

| | | Removal rate |
|---|---|---|
| | | (pH ~8.5, |
| Flow rate | Applied voltage | TDS ~200 ppm) |
| 0.5 L/min | 2.5 V DC | 72.5% |
| | 5 V DC | 91.0% |
| | 10 VDC | 92.2% |
| | (0, 10 V) AC, 10 Hz | 75.6% |
| | (0, 10 V) AC, 100 Hz | 78.3% |
| 1.5 L/min | 2.5 V | 64.9% |
| | 5 V | 76.3% |
| | 10 V | 86.0% |

### Example II

Table 2 shows test results of metal-ion removal effectiveness for the electrode set 800 of FIG. 8. The electrodes are made of carbon felt. The to-be-filtered water has TDS of 200 ppm and a pH of about 8.5. The water flow rate for the tests is 0.5 or 1.5 L/min. The power source provides various DC voltages of 5, 10, and 15 V. The removal rate of copper metal ions are effective at more than 50% to about 75%.

TABLE 2

| Flow rate (L/min) | Voltage (V) | Removal rate |
|---|---|---|
| 0.5 | 5 | 58.1% |
| | 10 | 67.9% |
| | 15 | 74.9% |
| 1.5 | 5 | 52.2% |
| | 10 | 54.3% |
| | 15 | 59.7% |

### Example III

Table 3 shows test results of metal-ion removal effectiveness for the electrode set 900 of FIG. 9. The electrodes are made of carbon felt. The to-be-filtered water has TDS of 200 ppm and a pH of about 8.5. The water flow rate for the tests is 0.5 or 1.5 L/min. The power source provides various DC voltages of 5 and 10 V. The removal rate of copper metal ions are effective at about 50%.

TABLE 3

| Flow rate (L/min) | Voltage (V) | Removal rate |
|---|---|---|
| 0.5 | 5 | 47.2% |
| | 10 | 50.3% |
| 1.5 | 5 | 40.2% |

### Example IV

Table 4 shows test results of metal-ion removal effectiveness for the water filter device 1210 shown in FIG. 12B. The electrodes are made of carbon felt. To test lead (Pb) removal effectiveness, the to-be-filtered water has TDS of about 152 ppb and a pH of about 6.5 or 8.5. To test copper (Cu) removal effectiveness, the to-be-filtered water has TDS of about 3050 or 3222 ppb and a pH of about 6.5 or 8.5. The water flow rate for the tests is 2.27 L/min. The removal rates are very effective at more than 97.5% and 80% for lead and copper metal ions, respectively.

TABLE 4

| | | Influent | Filter | |
|---|---|---|---|---|
| Target | Testing | Concentration | Effluent | Percent |
| Metal | parameter | (ppb) | (PPb) | Reduction |
| Pb | pH 6.5 | 152.01 | <3.20 | >97.89% |
| | pH 8.5 | 152.16 | <3.42 | >97.75% |
| Cu | pH 6.5 | 3049.90 | <600 | >80.00% |
| | pH 8.5 | 3222.38 | <620 | >80.80% |

### Example V

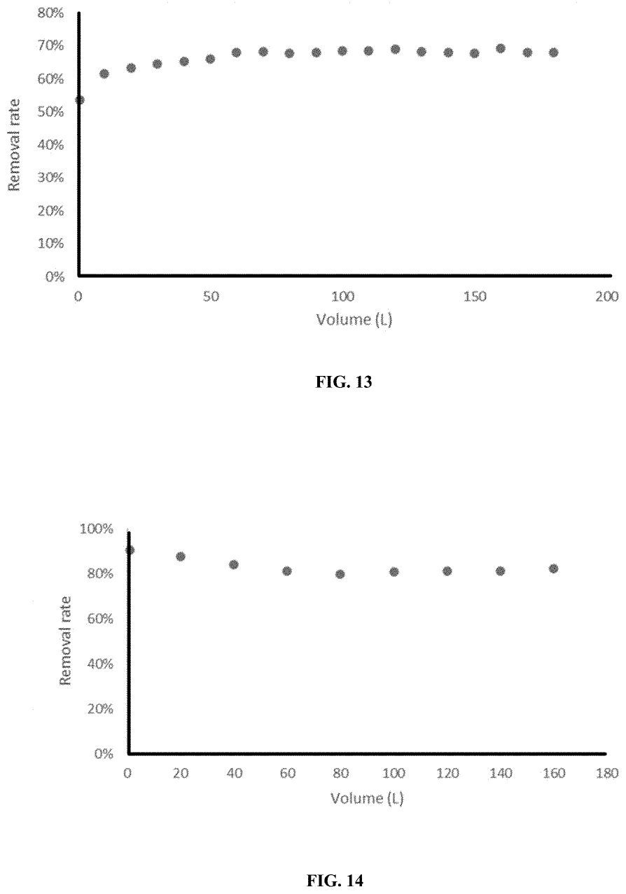

FIG. 13 is a diagram illustrating metal-ion removal rates versus water volumes for the water filter device 100 of FIG. 1. The electrodes of the water filter device 100 are made of carbon felt. The electrodes are 25 cm in length, 2.5 cm in height, and 3 mm in thickness. The to-be-filtered water has total dissolved solids (TDS) of 200 ppm and a pH of about 8.5. The water flows through the water filter device in a flow rate of 1.0 L/min. As shown in FIG. 13, the metal-ion (copper) removal rate is at more than 50% at the beginning to about 65% after treating about 180 L of the water. This indicates that the water filter device 100 is durable and effective in removing the Cu metal ions.

### Example VI

FIG. 14 is a diagram illustrating metal-ion removal rates versus water volumes for the water filter device 100 of FIG. 1. The electrodes of the water filter device 100 are made of carbon felt. The electrodes are 25 cm in length, 2.5 cm in height, and 3 mm in thickness. The to-be-filtered water has total dissolved solids (TDS) of 200 ppm and a pH of about 8.5. The water flows through the water filter device in a flow rate of 1.0 L/min. As shown in FIG. 12, the metal-ion (lead) removal rate is at more than 90% at the beginning more than 80% after treating about 170 L of the water. This indicates that the water filter device 100 is durable and effective in removing the lead metal ions.

### Example VII

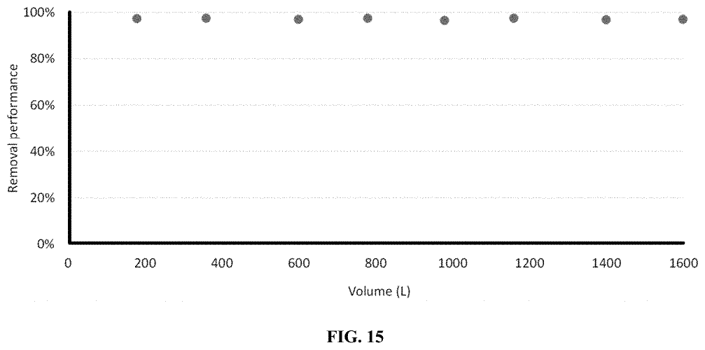

FIG. 15 is a diagram illustrating metal-ion removal rates versus water volumes for the water filter device 100 of FIG. 1. The electrodes of the water filter device are made of carbon felt. The electrodes are 25 cm in length, 2.5 cm in height, and 3 mm in thickness. In this test, the water filter device 100 includes two pairs of coiled electrodes. The to-be-filtered water has a lead ion concentration of 150 ppb. The water flows through the water filter device in a flow rate of 2.0 L/min. As shown in FIG. 15, the metal-ion (lead) removal rate is at more than 95% at the beginning more than 96% after treating 1600 L of the water. This indicates that the water filter device 100 is durable and effective in removing the lead metal ions.

The foregoing description of the present invention has been provided for the purposes of illustration and description. It is not intended to be exhaustive or to limit the invention to the precise forms disclosed. The breadth and scope of the present invention should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. An apparatus comprising:
a conduit including an inlet to receive a liquid and an outlet to discharge the liquid;
a first porous electrode disposed in the conduit, wherein the first porous electrode is extended in a first direction;
a second porous electrode disposed in the conduit and opposite to the first electrode, wherein the first porous electrode and the second porous electrode are separated by a gap or a non-conductive porous material;
a power source configured to provide power to the first porous electrode and the second porous electrode,
wherein a flow direction of the liquid in the conduit is not in parallel with the first direction.

2. The apparatus according to claim 1, wherein the power source provides an electrical field between the first porous electrode and the second porous electrode such that metal ions are electro-deposited onto a surface of the first porous electrode or the second porous electrode.

3. The apparatus according to claim 1, wherein the first porous electrode and the second porous electrode are sheet electrodes coiled together with the gap separating the first porous electrode and the second porous electrode, wherein the flow direction of the liquid in the conduit is substantially perpendicular to a tangential direction of the coiled sheet electrodes.

4. The apparatus according to claim 1, wherein each of the first porous electrode and the second porous electrode comprises a plurality of sheet electrodes, wherein the sheet electrodes of the first porous electrode are interlaced and in parallel with the sheet electrodes of the second porous electrode, wherein the flow direction of the liquid in the conduit is substantially in parallel with a normal direction of the sheet electrodes.

5. The apparatus according to claim 1, wherein the first porous electrode and the second porous electrode are sheet electrodes bent in a zig-zag shape with the gap separating the first porous electrode and the second porous electrode, wherein the flow direction of the liquid in the conduit traverses the zig-zag shaped sheet electrodes.

6. The apparatus according to claim 3, further comprising:
a case that houses the conduit, wherein the case includes a reservoir surrounding the conduit.

7. The apparatus according to claim 6, wherein the conduit includes a side wall having holes such that the liquid communicates from an inside of the conduit to the reservoir or from the reservoir to the conduit.

8. The apparatus according to claim 4, further comprising:
a case that houses the conduit, wherein the case includes a first compartment connected to the inlet, a second compartment configured to house the first porous electrode and the second porous electrode, and a separation structure disposed between the first compartment and the second compartment.

9. The apparatus according to claim 8, wherein the separation structure includes holes to allow the liquid to communicate from the first compartment to the second compartment.

10. The apparatus according to claim 1, wherein the first porous electrode and the second porous electrode comprise one of carbon felt or graphite felt with fibers.

11. The apparatus according to claim 10, wherein the fibers have a diameter of 1-100 μm inclusive.

12. The apparatus according to claim 1, wherein each of the first porous electrode and the second porous electrode has a thickness of 0.5-100 mm inclusive.

13. The apparatus according to claim 1, wherein at least one of the first porous electrode and the second porous electrode is functionalized with a material.

14. The apparatus according to claim 13, wherein the material comprises an amidoxime-based chemical.

15. The apparatus according to claim 13, wherein the material comprises a porous coating disposed on a surface of at least one of the first porous electrode and the second porous electrode.

16. The apparatus according to claim 1, wherein the power source provides a direct current or an alternating current to the first porous electrode and the second porous electrode.
